(19) United States
(12) Patent Application Publication
(10) Pub. No.: US 2010/0317222 A1
(43) Pub. Date: Dec. 16, 2010

(54) ELECTRICAL POWER EXTENSION CORD HAVING CONTINUOUS ELECTRICAL CURRENT AND GROUND MONITOR

(76) Inventors: CARL E. TOM, Monterey Park, CA (US); Victor Chan, La Mirada, CA (US)

Correspondence Address: CHRISTIE, PARKER & HALE, LLP, PO BOX 7068, PASADENA, CA, 91109-7068, US

(21) Appl. No.: 12/482,133

(22) Filed: Jun. 10, 2009

(51) Int. Cl. H01R 3/00

(52) U.S. Cl. 439/490

(57) ABSTRACT

An electrical power extension cord having a male plug end, a female receptacle end, and an insulated flexible cordset extending between the male and female ends of the extension cord. The male end has a first prong electrically connected to a hot wire contained in the cordset, a second prong electrically connected to a neutral wire in the cordset, and a third prong electrically connected to a ground wire in the cordset. The female end has a first receptacle electrically connected to a hot wire contained in the cordset, a second receptacle electrically connected to the neutral wire in the cordset, and a third receptacle electrically connected to the ground wire in the cordset. Continuous electrical current and ground monitoring circuits are contained in the male and female ends of the extension cord. Activation of indicator lamps contained in the monitoring circuits continuously indicates both electrical current and ground continuity between the male and female ends of the extension cord and electrical current at the male plug end.

### FIELD OF THE INVENTION

This invention relates to electrical extension cords, and more particularly, to an extension cord having continuous electrical current and ground monitoring during use.

### BACKGROUND

Electrical power extension cords must be maintained in safe operating conditions. This can be especially true for electrical power extension cords used in high electrical power-carrying facilities such as nuclear power plants and construction sites. Typically, electrical power extension cords and tools or equipment used at the site must be tested regularly for proper wiring conditions so as to comply with government safety regulations. U.S. agencies such as OSHA maintain regulations governing use of grounded appliances, tools, power cords and the like. Individual tests should be performed accurately without wasting too much downtime in carrying out the test procedures. In some instances in the prior art, portable electrical testing devices are used in which a power cord or a power-operated tool is connected into the test unit which tests electrical ground continuity. However, when such portable units are used for testing large numbers of devices, power cords, and the like, it can be time consuming; and in some instances, a break in electrical current or ground continuity may not be detected. Also, an electrical ground monitor connected to the male end of an extension cord may not detect an electrical short circuit caused by a break in the electrical ground within the cord itself. In addition there is no assurance that ground continuity is maintained in intervals between testing (usually quarterly per safety policy).

### SUMMARY OF THE INVENTION

The present invention comprises an electrical power extension cord that provides a continuous indication of electrical current at the male plug end and ground continuity along the length of the power cord.

In one embodiment, the electrical power extension cord normally operates from a standard 120-volt outlet which includes a female socket having the three contacts: hot, neutral and ground. The electrical power cord itself has a male plug at one end, a female receptacle at the other end, and a three-wire flexible cordset for maintaining electrical continuity between the male and female ends of the power cord.

The male plug end of the power cord has three electrical contacts connected to the hot, neutral and ground wires running through the cordset. A continuous electrical current monitor is embedded in the male plug end of the power cord. This monitor comprises an indicator lamp such as a neon bulb, an LED, or other optical indicator or lamp connected to the wires contained within the male end of the cord, for use in continuously monitoring electrical current entering the power cord through the male plug end, when the power cord is properly connected to a three-contact electrical power source.

The female end has three receptacle-type contacts electrically connected to the hot, neutral and ground wires running through the cordset. A continuous electrical ground continuity monitor is embedded in the female receptacle end of the power cord. This monitor comprises an indicator lamp such as a neon bulb, an LED, or other optical indicator or lamp connected to the wires contained within the receptacle end of the cord, for use in continuously monitoring electrical ground continuity between the male and female ends of the power cord when the power cord is properly connected to a grounded three-contact electrical power source.

The continuous electrical current monitor comprises a circuit containing a resistor connected to the hot wire contained in the male plug end and an indicator lamp having one terminal connected in series with the resistor and its other terminal connected to the neutral wire of the male plug end. During use, the indicator lamp continuously maintains an activated condition when active electrical current is coming from a power source through the male plug end of the power cord, when the power cord is properly coupled to a three-contact power source having electrical current.

The continuous ground monitor comprises a circuit containing a resistor connected to the hot wire contained in the receptacle and an indicator lamp having one terminal connected in series with the resistor and its other terminal connected to the ground wire of the receptacle. During use, the indicator lamp continuously maintains an activated condition when electrical ground continuity exists from the male plug end to the female receptacle end of the power cord, when the power cord is properly coupled to a three-contact power source having ground continuity.

The invention provides continuous assurance to the user that electrical current and ground continuity are both being maintained during use; and a break in either electrical current or ground continuity also can be indicated during use.

These and other aspects of the invention will be more fully understood by referring to the following detailed description and the accompanying drawings.

### BRIEF DESCRIPTION OF THE DRAWINGS

FIG. 1 is a schematic view illustrating an electrical power extension cord having both a continuous electrical current monitor and a continuous electrical ground monitor according to principles of this invention.

FIG. 2 is an electrical diagram illustrating a continuous electrical current and ground monitoring system contained in a female plug end of the extension cord.

FIG. 3 is an electrical diagram illustrating a continuous electrical current and ground monitoring system contained in a male plug end of the extension cord.

### DETAILED DESCRIPTION

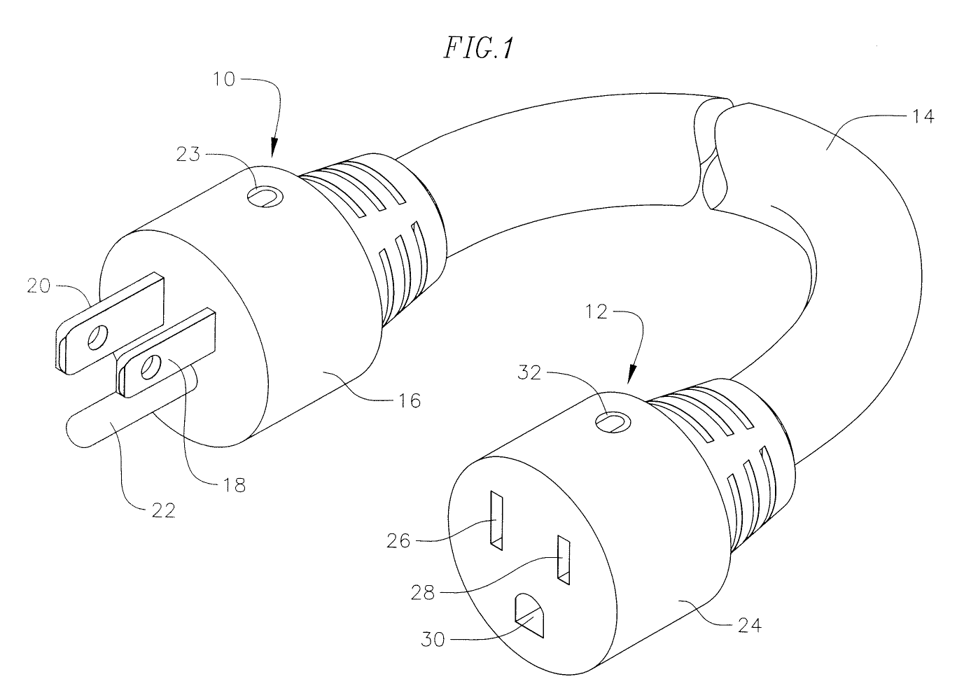

FIG. 1 illustrates an electrical power extension cord having both continuous current and ground monitor indicators. The power cord includes a male plug end 10, a female receptacle end 12, and a flexible cordset 14 extending between both ends of the extension cord. The flexible cordset includes an outer insulating jacket containing a cordset of the usual three electrical wires: hot, neutral and ground, each extending from one end of the extension cord to the other.

The male end 10 of the power cord includes an electrical insulating body 16 having three prongs: a power-carrying prong 20 connected to the hot power wire contained in the power cord, a neutral prong 18 connected to the neutral or return power wire contained in the power cord, and an electrical ground prong 22 connected to the ground wire running through the power cord.

The male end of the power extension cord also includes an indicator lamp 23 that provides a continuous electrical current monitor during use. The indicator lamp can be of various types, operated on a small amount of current, which may include a neon bulb, an LED, or a conventional lamp, referred to generally herein as an “indicator lamp.” The indicator lamp is embedded in the insulated receptacle end of the cord but is accessible from the exterior so as to be replaceable in its internal socket or contact. During use, the lamp is illuminated and remains continuously activated as long as an electrical current exists from the external electrical power source (such as a 120-volt wall socket) to which the male end of the power cord is connected. More specifically, the indicator lamp monitors whether there is active current coming from the outlet (power source) through the plug and thereby entering the power cord through the male plug end of the cord.

In one embodiment, the power extension cord comprises a NEMA 5-15 plug/receptacle, in which the power-carrying prong 20 at the male end has a rectangular shape with flat parallel sides, and a neutral prong 18 similar in shape but optionally slightly shorter (in cross-section) to maintain polarity during use. The ground prong 22 is optionally rounded and longer than the other two prongs. The NEMA 5-15 plug is rated for use with 120-volt, 15 ampere receptacle circuits, as standardized by the National Electrical Manufacturers Association.

The female end 12 of the power extension cord includes an electrical insulating body 24 having three receptacles: a power contact 28 connected to the hot power wire contained in the cordset, a neutral contact 26 connected to the neutral or return power wire contained in the cordset, and an electrical ground contact 30 connected to the ground wire in the cordset.

The female end of the power extension cord also includes an indicator lamp 32 that provides a continuous electrical ground continuity monitor during use. The indicator lamp can be of various types, operated on a small amount of current, which may include a neon bulb, an LED, or a conventional lamp, referred to generally herein as an “indicator lamp.” The indicator lamp is embedded in the insulated receptacle end of the cord but is accessible from the exterior so as to be replaceable in its internal socket or contact. During use, the lamp is illuminated and remains continuously activated as long as an electrical ground continuity exists from the external electrical power source (such as a 120-volt wall socket) to which the male end of the power cord is connected, and between the electrical ground terminals (ground contacts 22 and 30) of the power cord.

In one embodiment, the indicator lamps 23 and 32 are color coded so that the user can quickly determine whether electrical current and/or electrical ground continuity exist when the cord is plugged into a power source. In one example, the current monitor 23 can be a red or amber indicator lamp to act as a check light to indicate that power is on at the outlet. The ground monitor 32 can be a green indicator lamp to act as a check light to simultaneously indicate that the cord has ground continuity.

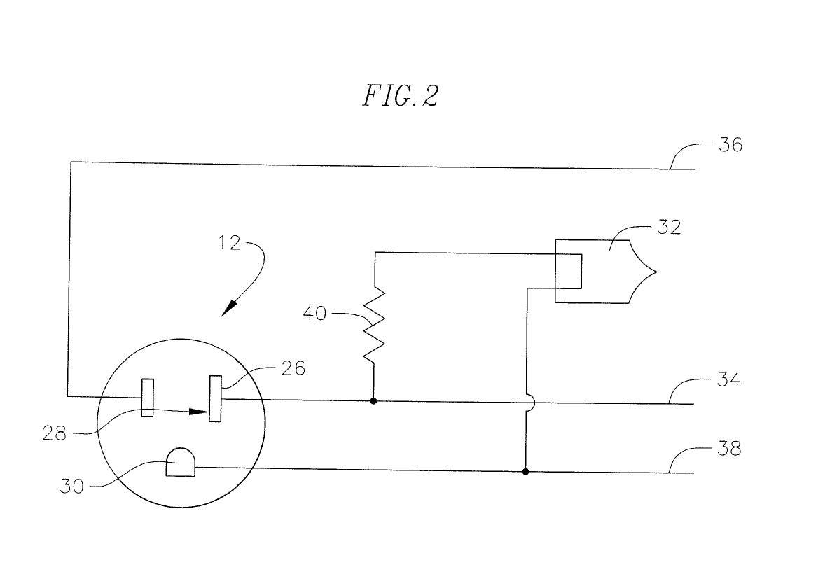

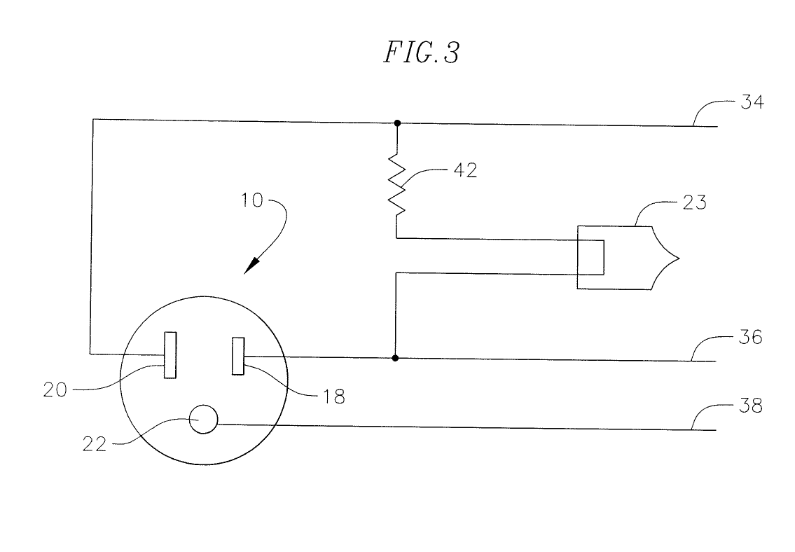

The continuous electrical current and ground monitors are best illustrated in FIGS. 2 and 3. FIG.2 illustrates the female receptacle end of the cord and the three electrical wires running through the cordset: a hot or positive wire 34 connected to the electrical power receptacle 26, a neutral or return wire 36 connected to the neutral receptacle 28, and a ground wire 38 connected to the ground terminal 30. The electrical ground monitor includes a resistor 40 connected to the positive or hot wire 34. The electrical ground indicator lamp 32 is connected in series with the resistor 40 between the hot wire 34 and the electrical ground wire 38.

FIG. 3 illustrates the male end of the cord, including the hot wire 34, the neutral wire 36 and the ground wire 38. The electrical current monitor includes a resistor 42 connected to the hot wire 34. The electrical current indicator lamp 23 is connected in series with the resistor 42 between the hot wire 34 and the neutral wire 36.

The resistors are of high electrical resistance which can be from about 100 to about 150 ohms, so that the indicator lamps may be operated on current in the milliamp range.

During use, a male end of the extension cord is connected to a three-contact electrical power source such as a standard 120-volt, 15 ampere electrical outlet receptacle. This connects the electrical ground prong 22 to the electrical ground contact of the power source. If the system is powered and continuous current and ground exists through the electrical extension cord, the indicator lamps 23 and 32 at the male and female ends of the cord are both continuously on—indicating the continuous electrical current and ground continuity from the source through the female end of the extension cord, and also indicating that a portable piece of equipment being used is connected to a properly grounded power cord.

If either of the indicator lamps is in an operative condition, but is not lit when the system is powered, this indicates that there is a break in current or ground continuity depending on which lamp is not lit.

The circuit shown in FIGS. 2 and 3 are schematic only. The components of the monitoring circuits are embedded within the male and female receptacle ends of the extension cord.

Also, the NEMA 5-15 plug/receptacle extension cord is simply one example of an extension cord having the continuous ground indicator. Other types of three-wire extension cords with three contacts at the male and female ends also can be adapted for using the continuous ground monitoring system.

What is claimed is:

1. An electrical power extension cord having a male plug end, a female receptacle end, and an insulated flexible cordset extending between the male and female ends of the extension cord,
the male end having an insulated body containing a first prong electrically connected to a hot wire contained in the cordset, a second prong electrically connected to a neutral wire in the cordset, and a third prong electrically connected to a ground wire in the cordset;
the female end containing a first receptacle contact electrically connected to a hot wire contained in the cordset, a second receptacle contact electrically connected to the neutral wire in the cordset, and a third receptacle contact electrically connected to the ground wire in the cordset; and
(a) a continuous electrical current monitoring circuit contained in the male end of the extension cord, the monitoring circuit including a resistor electrically connected to the hot wire in the male plug end, and an indicator lamp electrically connected in series between the resistor and the neutral wire in the male plug end of the extension cord, so that activation of the indicator lamp continuously indicates electrical current continuity entering the extension cord through the male plug end of the extension cord, and
(b) a continuous electrical ground monitoring circuit contained in the female end of the extension cord, the monitoring circuit including a resistor electrically connected to the hot wire in the female receptacle end, and an indicator lamp electrically connected in series between the resistor and the ground wire in the female receptacle end of the extension cord, so that activation of the indicator lamp continuously indicates electrical ground continuity between the male and female ends of the extension cord.

2. Apparatus according to claim 1 in which the male and female ends comprise a NEMA 5-15 plug/receptacle.

3. Apparatus according to claim 1 in which the lamp is replaceable.

4. Apparatus according to claim 1 in which the indicator lamp circuit and lamp are embedded in both the male and female ends of the extension cord.

5. Apparatus according to claim 1 in which the indicator lamps are color coded in different colors.
